(19) United States
(12) Patent Application Publication
(10) Pub. No.: US 2011/0284519 A1
(43) Pub. Date: Nov. 24, 2011

(54) REMOTE CONTROL DEVICE AND REMOTE CONTROL METHOD FOR WATER HEATER

(75) Inventor: MING-YUAN HSU, Tu-Cheng (TW)

(73) Assignee: HON HAI PRECISION INDUSTRY CO., LTD., Tu-Cheng (TW)

(21) Appl. No.: 12/841,128

(22) Filed: Jul. 21, 2010

(30) Foreign Application Priority Data
May 20, 2010 (TW) 99116048

(51) Int. Cl. H05B 1/02

(52) U.S. Cl. 219/492; 219/497

(57) ABSTRACT

A remote control device for a water heater includes a processing unit, a relay switch, a voltage measuring module, a current measuring module and a network connecting module. The relay switch is connected to the processing unit and configured to make the water heater connect or disconnect to an external power supply under the controlling of the processing unit. The voltage measuring module is connected to the processing unit and configured to measure a voltage value applied to the water heater, and transmit the voltage value to the processing unit. The current measuring module is connected to the processing unit and configured to measure a current value flowing through the water heater, and transmit the current value to the processing unit. The network connecting module is connected to the processing unit and configured to connect the processing unit to a remote computer.

### BACKGROUND

1. Technical Field

The present disclosure relates to remote control technologies, and particularly, to a remote control device and a remote control method for water heater.

2. Description of Related Art

A typical water heater generally includes a container for storing water, a heater for heating the water, a control circuit for controlling the heater, and may also include a remote controller for controlling the control circuit remotely. As such, users can start heating the water before they go back home. However, accidents might happen when the water heater works without surveillance.

Therefore, it is desirable to provide a new water heater which can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a functional block diagram of a remote control device for a water heater, according to one embodiment.

FIG. 2 is a viewing of a controlling interface for the remote control device of FIG. 1.

FIG. 3 is a flow chart of one embodiment of a remote control method.

### DETAILED DESCRIPTION

Embodiments of the present disclosure will now be described in detail with reference to the drawings.

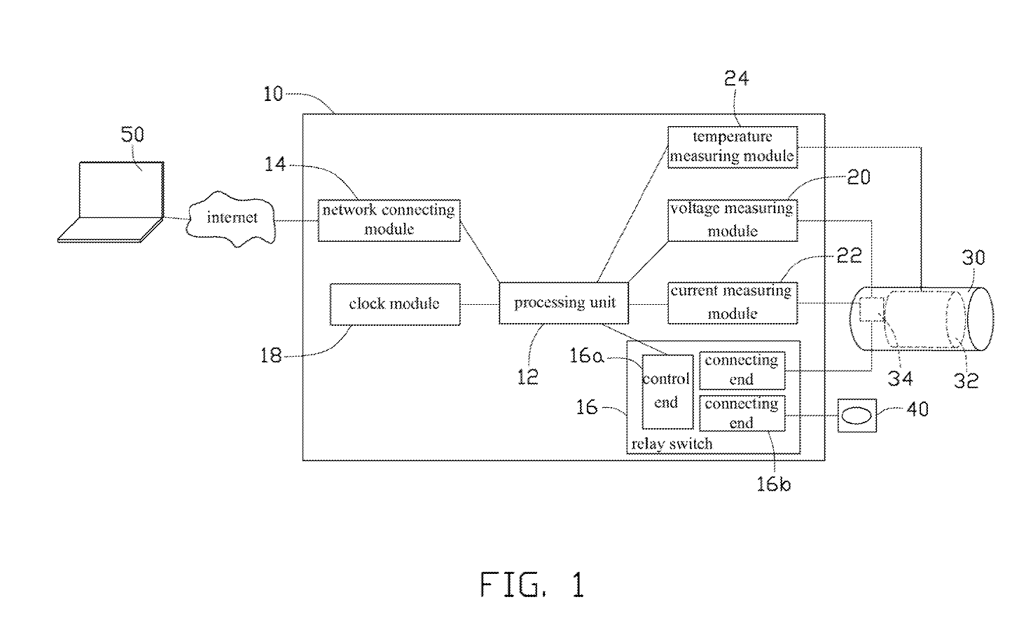

Referring to FIG. 1, a remote control device 10, according to one embodiment, is used to control a storage-type electrical water heater 30 remotely. The remote control device 10 and the water heater constitute a water heater system. The water heater 30 includes a power module 34 and a container 32. The power module 34 is connected to an external power supply 40 and used for processing the output of the external power supply 40 so that the external power supply 40 is usable and operable for the water heater 30. The container 32 is used for storing water (not shown). The control device 10 includes a processing unit 12, a network connecting module 14, a relay switch 16, a clock module 18, a voltage measuring module 20, a current measuring module 22, and a temperature measuring module 24.

The network connecting module 14 enables a remote computer 50 to connect the processing unit 12 via the internet. The network connecting module 14 can be an embedded gateway to connect to a broadband network or a dial-up internet access module, which connects the remote control device 10 to the internet and enables an interchange of information between the remote computer 50 and the processing unit 12.

The relay switch 16 is connected between the power module 34 and the external power supply 40, and configured to break the connection of the water heater 30 and the power supply 40. In detail, the relay switch 16 includes two connecting ends 16b and a control end 16a. The control end 16a is configured to control the two connecting ends 16b to connect or disconnect to each other. Each of the power module 34 and the external power supply 40 is connected to a respective one of the two respective connecting ends 16b, and the processing unit 12 is connected to the control end 16a. As such, the relay switch 16 is able to control the connection of the power module 34 and the external power supply 40 under the control of the processing unit 12.

The clock module 18 is connected to the processing unit 12. The clock module 18 is configured to transmit a real time clock to the processing unit 12. The voltage measuring module 20 is connected between the power module 34 of the water heater 30 and the processing unit 12. The voltage measuring module 20 is configured to measure a voltage value applied to the power module 34, and transmit the voltage value to the processing unit 12. The current measuring module 22 is connected between the power module 34 and the processing unit 12. The current measuring module 22 is configured to measure a current value flowing through the power module 34, and transmit the current value to the processing unit 12. The temperature measuring module 24 is connected between the container 32 of the water heater 30 and the processing unit 22. The temperature measuring module 24 is configured to measure a temperature value of the water in the container 32, and transmit the temperature value to the processing unit 12.

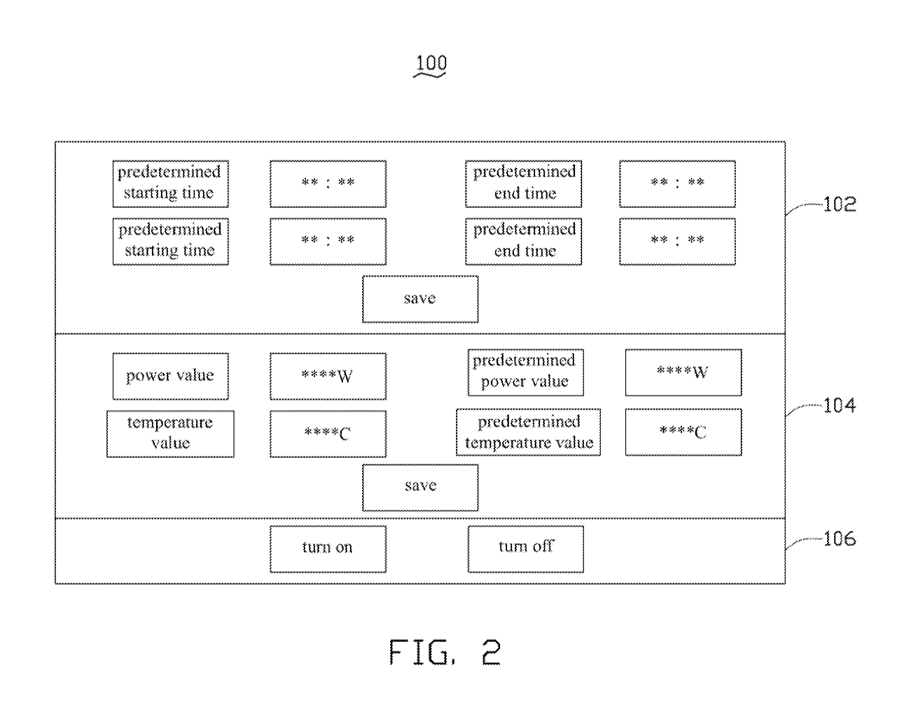

Also referring to FIG. 2, the remote computer 50 controls the remote control device 10 by running software control programs written in high-level computer language. In the present embodiment, the software control programs are written in visual basic language. When the software control program is running, the remote computer 50 generates an interface 100. The interface 100 can includes a time column 102, a parameter column 104, and a control column 106.

The time column 102 displays predetermined starting times and predetermined end times of the water heater 30 to the processing unit 12. The predetermined starting times and predetermined end times are adjustable. As such, users can set the predetermined starting times and predetermined end times as desired for the water heater remotely.

The parameter column 104 is configured to display a power value and a temperature value of the water heater 30, and allows a user to edit and set a predetermined power value and an predetermined temperature value remotely.

The control column 106 allows a user to turn on or turn off the water heater 30 in real time. In detail, the control column 106 includes a virtual “turn on” button and a virtual “turn off” button. When users click the “turn on” button or the “turn off” button, the water heater 30 is accordingly turned on or off.

In operation, the processing unit 12 reads the current time from the clock module 18, and compares the current time with the predetermined starting times and the predetermined end times. When the predetermined starting time arrives, the processing unit 12 controls the relay switch 16 to connect the power module 34 to the external power supply 40. Thus, the water heater 30 is turned on. When the predetermined end time arrives, the processing unit 12 controls the relay switch 16 to end the connection of the power module 34 and the external power supply 40. Thus, the water heater 30 is turned off.

During the time that the water heater 30 is working, the processing unit 12 receives the voltage value from the voltage measuring module 20 and the current value from the current measuring module 22, and calculates the power value of the water heater 30 accordingly. The power value is then transmitted to the remote computer 50 via the network connecting module 14 and the internet from the processing unit 12, and is displayed in the parameter column 104 on the remote computer 50. The processing unit 12 receives the temperature value of the container 32 from the temperature measuring module 24 and transmits the temperature value to the remote computer 50. The temperature value is then displayed in the parameter column 104.

The processing unit 12 compares the power value to the predetermined power value and compares the temperature value to the predetermined temperature value. When the power value exceeds the predetermined power value or the temperature value exceeds the predetermined temperature value, the processing unit 12 controls the relay switch 16 to turn off the water heater 30.

Users can set the predetermined power value by reference to the normal rating power of the water heater 30. When the water heater 30 is not working properly, for example, if there is an electrical leakage, the power value jumps higher than the normal rated power. In another example, the water heater 30 may start heating the container 32 when there is no water or not enough water to heat, the temperature value rises quickly and goes beyond the predetermined temperature value. In all scenarios, the remote control device 10 can monitor the water heater and shut off the water heater in case the water heater is not working properly. As such, accidents can be avoided

In alternative embodiments, analyzing whether the temperature value exceeding the predetermined temperature value may be omitted, as it represents that the water heater is working inappropriately when the power value jumps higher than the predetermined power value.

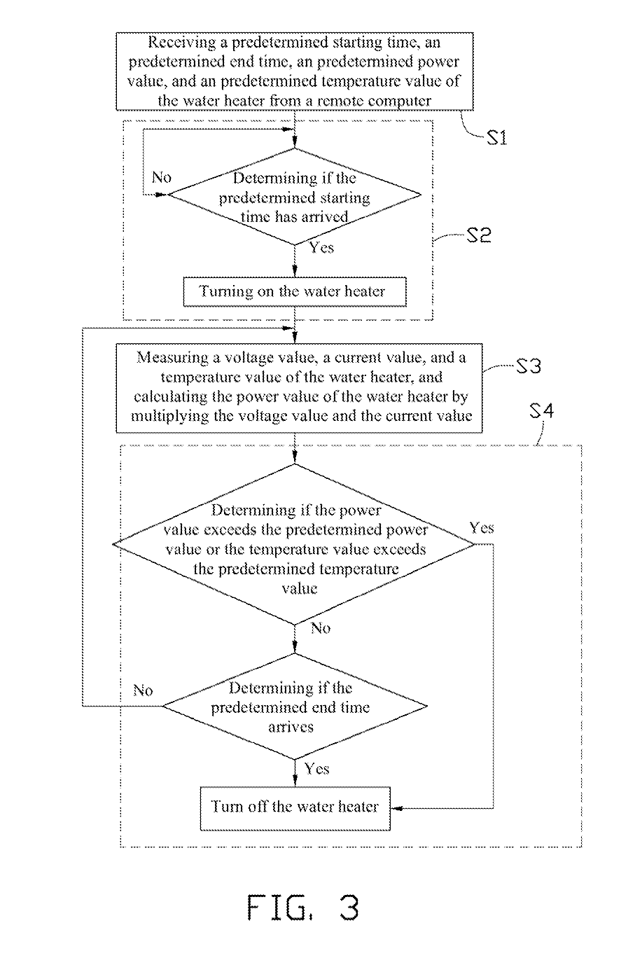

Referring to FIG. 3, a remote control method for a water heater, according to one embodiment, includes the following steps:

S1: Transmitting predetermined starting time, a predetermined end time, an predetermined power value, and an predetermined temperature value of a water heater from a remote computer;

S2: Determining if the predetermined starting time has arrived, and if so, turning on the water heater. Otherwise, repeating this step until the predetermined starting time arrives;

S3: Measuring a voltage value, a current value, and a temperature value of the water heater, and calculating the power value of the water heater by multiplying the voltage value and the current value;

S4: Determining if the power value exceeds the predetermined power value or the temperature value exceeds the predetermined temperature value, and if so, turning off the water heater. Otherwise, determining if the predetermined end time has arrived, and if not, returning to the previous step, but if so, turning off the water heater.

It will be understood that the above particular embodiments is shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A remote control device for a water heater, the remote control device comprising:
a processing unit;
a relay switch connected to the processing unit and configured to make the water heater connect or disconnect to an external power supply under the controlling of the processing unit;
a voltage measuring module connected to the processing unit, configured to measure a voltage value applied to the water heater, and transmit the voltage value to the processing unit;
a current measuring module connected to the processing unit, configured to measure a current value flowing through the water heater, and transmit the current value to the processing unit; and
a network connecting module connected to the processing unit and configured to connect the processing unit to a remote computer;
wherein the processing unit is configured to calculate a power value according to the current value from the current measuring module and the voltage value from the voltage measuring module, and determine whether the power value exceeds a predetermined power value, thereby obtaining a determination result, the processing unit is also configured to control the relay switch to make the water heater connect or disconnect to the external power supply according to the determination result.

2. The remote control device of claim 1, wherein the relay switch comprises two connecting ends and a control end, the two connecting ends are configured to be connected to the water heater and the external power supply, and the control end is configured to control the two connecting ends to connect or disconnect to each other such that the water heater connects or disconnects to the external power supply.

3. The remote control device of claim 1, wherein the network connecting module is an embedded gateway or a dial-up internet access module.

4. The remote control device of claim 1, further comprising a clock module connected to the processing unit and configured to provide a current time to the processing unit; wherein the processing unit is configured to determine whether a predetermined starting time or a predetermined end time arrives according to the current time, thereby controlling the relay switch to make the water heater connect or disconnect to the external power supply.

5. The remote control device of claim 1, further comprising a temperature measuring module connected to the processing unit and configured to measure a temperature value of the water heater, and transmit the temperature value to the processing unit; wherein the processing unit is configured to determine whether the temperature value exceeds a predetermined temperature value thereby controlling the relay switch to make the water heater connect or disconnect to the external power supply.

6. A remote control method for a water heater, comprising:
receiving a predetermined starting time, an predetermined end time, an predetermined power value, and an predetermined temperature value of the water heater from a remote computer;
determining if the predetermined starting time has arrived, and if so, turning on the water heater, otherwise, repeating this step until the predetermined starting time arrives;
measuring a voltage value, a current value, and a temperature value of the water heater, and calculating the power value of the water heater by multiplying the voltage value and the current value; and
determining if the power value exceeds the predetermined power value or the temperature value exceeds the predetermined temperature value, and if so, turning off the water heater, otherwise, determining if the predetermined end time arrives, and if so, turning off the water heater, otherwise, returning to the previous step.

7. The remote control method of claim 6, wherein the remote computer transmits the predetermined starting time, the predetermined end time, the predetermined power value, and the predetermined temperature value of the water heater through the internet.

8. The remote control method of claim 6, wherein the predetermined starting time and the predetermined end time are set by using the remote computer.

9. The remote control method of claim 6, wherein the predetermined power value and the predetermined temperature value are set by using the remote computer.

10. A water heater system, comprising:
a water heater, comprising:
a container for storing water; and
a power module for converting an external power supply appropriate for the water heater; and
a remote control device, comprising:
a processing unit;
a relay switch connected to the processing unit and configured to make the water heater connect or disconnect to an external power supply under the controlling of the processing unit;
a voltage measuring module connected to the processing unit, configured to measure a voltage value applied to the water heater, and transmit the voltage value to the processing unit;
a current measuring module connected to the processing unit, configured to measure a current value flowing through the water heater, and transmit the current value to the processing unit; and
a network connecting module connected to the processing unit and configured to connect the processing unit to a remote computer;
wherein the processing unit is configured to calculate a power value according to the current value from the current measuring module and the voltage value from the voltage measuring module, and determine whether the power value exceeds a predetermined power value, thereby obtaining a determination result, the processing unit is also configured to control the relay switch to make the water heater connect or disconnect to the external power supply according to the determination result.

11. The water heater system of claim 10, wherein the relay switch comprises two connecting ends and a control end, the two connecting ends are configured to be connected to the water heater and the external power supply, and the control end is configured to control the two connecting ends to connect or disconnect to each other such that the water heater connects or disconnects to the external power supply.

12. The water heater system of claim 10, wherein the network connecting module is an embedded gateway or a dial-up internet access module.

13. The water heater system of claim 10, further comprising a clock module connected to the processing unit and configured to provide a current time to the processing unit; wherein the processing unit is configured to determine whether a predetermined starting time or a predetermined end time arrives according to the current time thereby controlling the relay switch to make the power module connect or disconnect to the external power supply.

14. The water heater system of claim 10, further comprising a temperature measuring module connected to the processing unit and configured to measure a temperature value of the container, and transmit the temperature value to the processing unit; wherein the processing unit is configured to determine whether the temperature value exceeds a predetermined temperature value thereby controlling the relay switch to make the power module connect or disconnect to the external power supply.
